(19) United States
(12) Patent Application Publication
(10) Pub. No.: US 2024/0286115 A1
(43) Pub. Date: Aug. 29, 2024

(54) METHOD FOR PRODUCING CATALYSTS FOR HIGH TEMPERATURE CHEMICAL PROCESSES AND CATALYSTS THUS OBTAINED

(71) Applicant: NEXTCHEM TECH S.P.A, Roma (IT)

(72) Inventors: Luca Eugenio Riccardo Basini, Milano (IT); Gaetano Iaquaniello, Roma (IT); Annarita Salladini, Roseto degli Abruzzi (IT)

(21) Appl. No.: 18/569,258

(22) PCT Filed: Jun. 14, 2022
(86) PCT No.: PCT/EP2022/066105

§ 371 Date: Dec. 12, 2023

(30) Foreign Application Priority Data
Jun. 14, 2021 (IT) 102021000015473

(51) Int. Cl. B01J 23/46; B01J 37/02; B01J 37/08

(52) U.S. Cl. CPC B01J 23/46; B01J 37/0203; B01J 37/0213; B01J 37/08

(57) ABSTRACT

Method of preparing a catalyst comprising catalytic species consisting of transition metals deposited on a support, comprising the steps of contacting a solution of a metal-carbonyl or other organometallic complex of the transition metal with a support, carrying out the deposition and the surface interaction of the transition metal on the surface of the support and causing the carbonyl metal or the organic complex to decompose as a result of at least one heat treatment. The catalyst obtained is advantageously used in the production of synthesis gas and in other high temperature industrial chemical processes.

The present invention relates to a method for producing catalysts for high temperature chemical processes and the catalysts thus obtained.

### BACKGROUND ART

Most of the methods for preparing industrial catalysts for high temperature chemical processes that occur in the heterogeneous phase, such as those used in the production of synthesis gas, an intermediate for important chemical and refining processes, use incipient wet impregnation (“IWI”) procedures. These procedures involve:
(A) the physical adsorption of an aqueous solution of inorganic salts on the porous layers of a support material in powder form, in the form of discrete particles with various shapes (pellets) or with a monolithic structure, for example in the shape of a honeycomb, of foam, or mesh. These support materials, hereinafter also referred to simply as “support”, may consist of:
   i) inorganic oxides containing only one cation (e.g. Al₂O₃, MgO, ZrO₂, Ce₂O₃) and mixed inorganic oxides containing several cations, such as for example the “spinels” of Mg—Al oxides, perovskites, hydrotalcites, yttrium stabilized zirconium oxides;
   ii) metal supports on whose surfaces porous oxidic layers suitable for impregnation have grown (e.g. FeCrAl alloys on whose surfaces porous oxidic layers are grown with various methods);
(B) a drying phase of the surfaces impregnated with the aqueous solutions of inorganic salts (e.g. nitrates, halides of Ni, Co, Fe and noble transition metals such as Rh, Ru, Ir, Pt, Pd), typically at temperatures above 100° C.
(C) a calcination phase, in which the inorganic salts are decomposed at high temperatures, for example 450-800° C., producing inorganic gaseous species (for example NOx, halogens) and oxidic and/or metallic structures on the surfaces of the supports of the catalysts containing the catalytically active centres.

Furthermore, in most cases, a further activation step of the catalyst is required before its use. For example, Ni-based catalysts for Steam Reforming (SR) after their insertion in the reactors and before starting the plants, require a further hydrogenation step to reduce the surface species of NiO to metallic Ni species. It should be noted that the described procedure, in particular due to the high temperature treatments, does not allow the achievement of specific catalytic centres with characteristics defined at the molecular level and moreover require the use of relevant percentages of active metals (e.g., the SR catalysts contain percentages of Ni even higher than 15% by weight). Furthermore, the high temperature thermal treatments require heating furnaces utilising electric energy or more frequently, the combustion of hydrocarbon compounds. These furnaces, during the heating and decomposition of inorganic salts, produce, in addition to CO₂, also toxic inorganic gaseous species, which cannot be released into the atmosphere before receiving adequate treatment.

Furthermore, many of the catalysts prepared with these methods, and containing transition metals such as Ni, have thermodynamic affinity limits towards the carbon formation reactions which impose, for example in the synthesis gas production processes, minimum values of the ratios between the moles of steam and the moles of carbon atoms (ratios called Steam/Carbon or S/C) in the mixture of reactants, and of minimum values of the ratios between the moles of oxygen and the moles of carbon atoms (ratios O₂/C) in the AutoThermal Reforming (ATR), Non-Catalytic Partial Oxidation (POx) and Catalytic Partial Oxidation (CPO) and Short Contact Time—Catalytic Partial Oxidation—(SCT-CPO) whose main characteristics are described here below.

### Production of Synthesis Gas

The synthesis gas is industrially produced with steam reforming (SR), Non-catalytic Partial Oxidation (POx) and Autothermal Reforming (ATR) technologies. A relatively recent variant of the SR process is the Gas Heated Reforming (GHR) process which, at least partially, replaces the radiant heat necessary for the endothermic catalytic steam reforming reactions with a convective source, typically consisting of: i) hot gases produced by total combustion reactions; and/or ii) the high temperature synthesis gas produced by ATR or POx processes. Moreover, when SR and GHR technologies are integrated with ATR or POx technologies, these are referred to as Combined Reforming (CR) processes. The features of the technologies briefly reported above are described in numerous literature documents and among those we mention:
“Technologies for large-scale gas conversion” Aasberg-Petersen, K., Bak Hansen, J.-H., Christensen, T S, Dybkjaer, I., Christensen, P. Seier, Stub Nielsen, C., Winter Madsen, SEL, Rostrup-Nielsen, JR, Applied Catalysis A: General, 221 (1-2), p. 379, November 2001;
“Synthesis Gas production by Steam Reforming”, Dybkjaer, Ib; Seier Christensen P.; Lucassen Hansen V.; Rostrup-Nielsen J. R., EP1097105A1;
“Catalytic Steam Reforming”; Rostrup-Nielsen J. R.; pp-1-117, Catalysis Vol. 5, Edited by John R. Anderson and Michel Boudart,

The Short Contact Time—Catalytic Partial Oxidation (SCT-CPO) technology is not yet industrially applied but is described in numerous patent documents, among which we may cite: (A1), WO2016016257 (A1), WO2016016256 (A1), WO2016016253 (A1), WO2016016251 (A1), WO 2011151082, WO 2009065559, WO 2011072877, US 2009127512, WO 2007045457, WO 2006034868, US 2005211604, WO 2005023710, WO 9737929, EP 0725038, EP 0640559.

The following literature documents are also cited:
“Issues in H₂ and synthesis gas technologies for refinery, GTL and small and distributed industrial needs”; Basini, Luca, Catalysis Today, 106 (1-4), p. 34, October 2005,
“Fuel rich catalytic combustion: Principles and technological developments in short contact time (SCT) catalytic processes”; Basini, L.; Catalysis Today, 117 (4), 384-393; DOI: 10.1016/j.cattod.2006.06.043 Published: 15 Oct. 2006,
“Natural Gas Catalytic Partial Oxidation: A Way to Syngas and Bulk Chemicals Production | IntechOpen”; G. Iaquaniello, E. Antonetti, B. Cucchiella, E. Palo, A. Salladini, A. Guarinoni, A. Lainati and L. Basini; http://dx.doi.org/10.5772/48708
“Short Contact Time Catalytic Partial Oxidation (SCT-CPO) for Synthesis Gas Processes and Olefins Production”; L. E. Basini, A. Guarinoni, Ind. Eng. Chem. Res. 2013, 52, 17023-17037; https://doi.org/10.1021/ie402463m

Synthesis gas is used in many chemical processes including the synthesis of methanol and its derivatives, the synthesis of ammonia and urea, the synthesis of liquid hydrocarbons with the Fischer-Tropsch process and the production of hydrogen, which in turn has numerous uses in refining processes, in petrochemical and fine chemical processes, in the electronics industry, in metal refining and in the food industry. The aforementioned industrial processes require different compositions of the synthesis gas, both for improving their energy efficiency and for reducing the greenhouse gas (GHG) emissions.

Furthermore, the use of synthesis gas in the reduction processes of ferrous minerals, is also increasing although, till now, it is marginally used only in Direct Reduction (DR) processes. In this case the synthesis gas is currently produced by SR processes in which a relevant amount of CO₂ is added to the steam in the reagent mixtures (Steam CO₂ Reforming—SCR processes).

### Catalysts for the Partial Catalytic Oxidation Reaction

The most active transition metal species, also described in literature, for catalytic partial oxidation (CPO) reactions, and particularly for low contact time—catalytic partial oxidation (SCT-CPO) reactions, include Rh, Ir, Ru and Ni, also combined with each other. Rh is the preferred choice among the noble metals, both for its chemical reactivity features and because the Rh, among the mentioned metals, has a the highest Tamman temperature. The latter is the half of the metal melting temperature and is considered the temperature at which the surface aggregation processes of the atomic species (sintering) begin, leading to the formation of large metal aggregates with the effect of reducing the dispersion of the active catalytic centres and the worsening the catalyst intrinsic reactivity features. These points are also described in:
R. Merkle und J. Maier Stuttgart (Max Planck Institut für Festkörperforschung), Z. Anorg. Allg. Chem. 2005, 631, 11631166 (DOI:10.1002/zaac.200400540);
“Fuel rich catalytic combustion: Principles and technological developments in short contact time (SCT) catalytic processes”; L. Basini; Catalysis Today 117 (2006) 384-393;
“Two-dimensional modeling of partial oxidation of methane on Rhodium alumina support in a short contact time reactor”; O. Deutschman, L. D. Schmidt, AIChE Journal; 44 (1998) pp. 2465-2477

Noteworthy, the Rh and Ir species have peculiar applications in the initial part of the catalytic beds in which the CPO or SCT-CPO reactions are carried out, while the use of catalysts containing Ru and Ni, which can form volatile and toxic oxidic species, is preferable in the subsequent zones of the catalytic beds, in which the mixture of reactants has a low partial pressure of Oxygen (P_{O2}) and in which the molecules with reducing properties, i.e., CO and H₂, are the main components. More specifically, it is reported that the Ni containing catalysts are particularly useful, when the P_{O2} is almost zero in the terminal part of the catalytic beds for completing the SCR reactions but also for converting any unsaturated hydrocarbon compounds, formed at the beginning of the catalytic bed, in CO and H₂, as described for example in US2017173568 A1 (B2). Indeed, the formation of unsaturated compounds in synthesis gas mixtures must be avoided in order to prevent their accumulation in the reactors and in the heat exchanger surfaces generating steam and placed downstream the reactors for cooling the synthesis gas before its utilisation, as it occurs for example in the aforementioned ammonia and urea production processes, the production of methanol and its derivatives, of hydrogen and in the Fischer-Tropsch processes.

The catalytically active metals in the CPO and/or SCT-CPO processes, mentioned above, can be deposited with various procedures on the surfaces of the oxidic supports, such as the aluminium, magnesium, cerium, zirconium, lanthanum oxides and other oxides also mixed oxides also containing other different cationic species and having different structures, but also on metallic supports. Furthermore, the supports can have the form of pellets with various geometries, or of monoliths, such those with honeycomb structures, those with a foam structure or, in the case of metal supports, with mesh and gauze structures of various kinds.

As already mentioned, the industrial procedures for depositing catalytically active metals on catalyst supports use Incipient Wetness Impregnation (IWI) methods with aqueous solutions of inorganic salts (see for example U.S. Pat. No. 5,336,655) and, as mentioned above, the known processes have obvious drawbacks, such as the need of carrying out thermal treatments or “calcination” at high temperature treatments which reduce the dispersion of the catalytically active metals, therefore requiring the use of large quantities of catalytically active metals and lead to the emission of toxic substances, during the decomposition of the inorganic salts, which cannot be released as such into the atmosphere and must be removed from the exhaust gases.

In addition, the high temperature thermal treatments require heating furnaces consuming relevant amounts of energy. Furthermore, the obtained catalysts require activation processes in some contexts. For example, in the case of catalysts which having high Ni contents (typically higher than 15% by weight) such those used in SR processes, activation processes are required to convert the oxidized species into metallic Ni species before their use. The low dispersion and the high quantities of catalytically active metals also increase the thermodynamic affinity towards the reactions of formation of carbonaceous species and impose limits on the S/C and O₂/C ratios in the reagent mixtures which are not always suitable for producing optimal synthesis gas compositions for the downstream processes utilising the synthesis gas with an overall reduction of the energy efficiency of catalytic processes.

The need is therefore felt to have available new methods for producing catalysts for industrial chemical processes which eliminate or reduce the drawbacks of known methods.

### SUMMARY OF THE INVENTION

One aspect of the present invention therefore relates to a method for preparing catalysts for chemical processes comprising catalytic species consisting of one or preferably more transition metals, or compounds of said transition metals, deposited on a support, characterized by comprising:
a) preparing a solution in an organic solvent of an organometallic compound of said transition metal forming said catalytic species and contacting it with said support, in which said organometallic compound is selected among the metal-carbonyls and complexes with organic ligands of said transition metal, and said support is selected from the group consisting of inorganic oxides, nitrides, oxy-nitrides, carbides, borides and metal compounds on the surface of which oxidic structures are formed;
b) depositing said solution of the organometallic compound of the transition metal on the surface of said support with chemisorption or physisorption processes;
c) removing the organic solvent of the solution of said transition metal deposited on the surface of said support, and totally or partially decomposing said organometallic compound of the transition metal remaining on the surface of said support by effect of at least one heat treatment, whereby one or more catalytic species of said transition metal are deposited on said support.

Another aspect of the invention relates to the catalyst obtained with the above method. A further aspect of the invention is the use of said catalyst in CO₂ reforming (CR), Steam Reforming (SR), Steam-CO₂ reforming (SCR), partial catalytic oxidation (CPO) and short contact time—catalytic partial oxidation (SCT-CPO) processes for the production of synthesis gas.

### DESCRIPTION OF THE INVENTION

The invention is hereinafter described also with reference to the accompanying figures, in which:

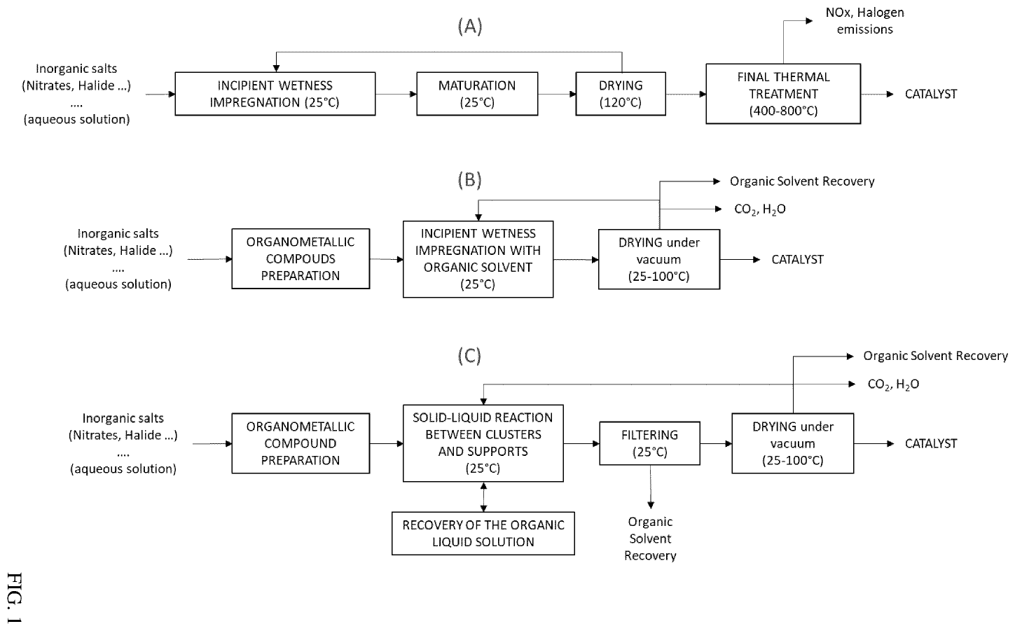

FIG. 1A is a diagram of a method for preparing a catalyst according to the prior art; and

FIGS. 1B-C, 2, 3, 4, 5 and 6 are diagrams of embodiments of the method for preparing a catalyst according to the invention.

According to one aspect of the invention, the reactions for preparing industrial catalysts and the reactions for producing synthesis gas are advantageously carried out with the use of organic solutions of organometallic complexes of the transition metals, wherein said organometallic complexes consist of metal-carbonyls and/or complexes with organic ligands of transition metals.

In the remainder of the description, the terms “organometallic compounds” or “organometallic complexes” of transition metals are used interchangeably.

The carbonyl compounds, in addition to the physical interactions with the surfaces of the catalyst supports, are also able to develop chemical interactions, allowing a selective grafting of the catalytically active metal on the chemically active sites of the support species, for example the coordinatively unsaturated sites (c.u.s.) and the Bronsted and/or Lewis acid sites. With reference to step b) of the method defined above, the term “chemi-sorption” indicates an adsorption with chemical transformation of the adsorbed organometallic compound and the term “physi-sorption” indicates an adsorption without chemical transformation and decomposition of the adsorbed compound);

According to an aspect of the invention, the carbonyl compounds can also be selected so that during their decomposition only CO₂ and H₂O are desorbed.

Furthermore, the interaction between these organometallic compounds with the support can be adapted in order to produce mono-layers, or less than a monolayer, of catalytically active metal surface species simply by removing the organic solvent with a vacuum treatment at room temperature and after a moderate drying step even at temperatures below 100° C.

If organometallic compounds are appropriately selected, the reactions between their organic solution and the surfaces of the catalyst supports can be directed towards the formation of monometallic species or surface clusters with two or more metal atoms having peculiar, unpredictable reactivity properties on the basis of the known features of the organometallic compounds in solution or of the metal compounds obtained on the surfaces of the same catalytic supports with incipient wettability processes using aqueous solutions of inorganic salts of the same transition metals.

The carbonyl compounds can be selected from those that can be obtained with simple carbonylation reactions of precursors of inorganic salts, such as for example: Rh₄(CO)₁₂, Rh₆(CO)₁₆, Ru₃(CO), Ir₄(CO)₁₂, Fe₂(CO)₉, Fe₃(CO)₁₂, Co₂(CO)₈, Co₄(CO)₁₂, Co₆(CO)₁₆.

Alternatively, complexes of transition metals with organic ligands, such as acetyl acetonates (Acac=CH₃COCHCOCH₃⁻), in which the transition metals are for example Ni, Fe, Co, or noble transition metals such as Rh, Ru, Ir, Pt, Pd can be used.

The method of the invention not only improves the known preparation methods of the catalysts but also the performance of the resulting catalysts. In particular, it is advantageous to use the catalysts in the processes of: i) CO₂ reforming (CR), ii) steam-CO₂ reforming (SCR), iii) Catalytic Partial Oxidation (CPO) or Short Contact Time Catalytic Partial Oxidation (SCT-CPO), which produce synthesis gas that can be used in the processes for the production of ammonia/urea, methanol and its derivatives, hydrogen, as well as in other processes that still use the synthesis gas produced with these methods to a limited extent, such as processes of reduction of ferrous minerals.

According to the invention, the use in the preparation of catalysts, of organometallic compounds, in particular those which include ligands consisting of CO alone, such as Rh₄(CO)₁₂, Rh₆(CO)₁₆, Ru₃(CO)₁₂, Ir₄ (CO)₁₂, Fe₂(CO)₉, Fe₃(CO)₁₂, Co₂(CO)₈, Co₄(CO)₁₂, Co₆ (CO)₁₆, allows the following advantages to be obtained:
i) the deposition of catalytic metals through the selective interaction between the organometallic clusters and the reactive sites of the surfaces of the catalytic supports, obtaining materials with high dispersion of the catalytic sites in which it is possible to reduce the quantities of transition metals while maintaining performances equal to or better than the values of catalytic activity, and therefore of the combined conversion values of the reactants and selectivity towards CO and H₂ with respect to the catalysts obtained with incipient wettability processes which use aqueous solutions of inorganic salts of the same transition metals;
ii) the possibility of obtaining the final catalysts to be used in the reactors using mild thermal treatments, thus avoiding the high-temperature calcination steps necessary for the decomposition of the adsorbed inorganic salts with the incipient wettability method that uses aqueous solutions, thus avoiding NOx emissions or other polluting inorganic gaseous compounds;
iii) the reduction of metal waste during the preparation of large quantities of industrial catalysts compared to procedures that use aqueous solutions of inorganic salts that are sprayed on the catalytic supports up to reaching the incipient wettability values of the same, which are subsequently dried by evaporating the aqueous solution;
iv) the production of monolithic catalysts with high dispersion of active metals, and therefore of catalytic centres, both in cases where supports in the form of pellets are used and in cases where supports with monolithic structures are used, particularly useful for use in CPO and/or SCT-CPO reactors, in which the reduction of the pressure drop in the reactors is critical, therefore to allow the implementation of more advantageous low pressure operating conditions, for example in the reduction processes of ferrous minerals.

It should be emphasized that the use of organic solutions of the carbonyl clusters allows both:
i) the deposition of active metals with incipient wetness impregnation (IWI) procedures with organic solutions; and
ii) the deposition of active metals through solid-liquid reactions obtained by dispersing the solid supports in organic solutions containing the carbonyl clusters.

In this regard, extensive studies have been published in the scientific literature on the formation and reactivity features of the surface metal species produced by a solid-liquid reaction between the Rh₁₂(CO) 12, Ir₄(CO) 12 e Ru₃(CO) 12 clusters dispersed in n-hexane or THF solvents and the active surface sites of MgO, α-Al₂O₃, CeO₂, La₂O₃, ZrO₂ and TiO₂.

See in this regard:
“Drift and Mass Spectroscopic Studies on the Reactivity of Rhodium Clusters at the Surface of Polycrystalline Oxides” L. Basini, M. Marchionna and A. Aragno; J. Phys. Chem., Vol. 96, No. 23, 1992
“Molecular and Temperature Aspects in Catalytic Partial Oxidation of Methane”; L. Basini, A. Guarinoni, A. Aragno; J. Catalysis, 190 (2000) pp. 284-295
“Catalytic partial oxidation of natural gas at elevated pressure and low residence time”; L. Basini, K. Aasberg-Petersen, A. Guarinoni, M. Østberg; Catalysis Today 64 (2001) 9-20
“In Situ EXAFS Study of Rh/Al₂O₃Catalysts for Catalytic Partial Oxidation of Methane”; J. D. Grunwaldt, L. Basini, B. S. Clausen*; J. Catal. 200 (2001) pp. 321-329
“DRIFT and Mass Spectrometric Experiments on the Chemistry and Catalytic Properties of Small Ir Clusters at the Surfaces of Poly-crystalline α-Al₂O₃”, L. Basini and A. Aragno, J. C. S. Faraday Trans. 1994, 90(5), 787-795;
“Molecular Aspects in Syngas Production: the CO₂ Reforming Case”; L. Basini, D. Sanfilippo, J. Catal 157(1995) pp. 162-178

### Reduction Processes of Iron Ores and Use of Synthesis Gas

The processes of reduction of ferrous minerals for steel production mainly use blast furnaces (BF) and to a less extent direct reduction (DR) processes and to an even lesser extent the Smelting Reduction methods.

More specifically, in steel production processes using blast furnaces (BF) there are sustainability issues related to the polluting emissions involved in the production and use of coke and in the preparation of ferrous minerals, which requires crushing, sintering and pelletizing.

Overall, pollutant emissions include mono and poly-cyclic aromatic hydrocarbons, sulphur compounds, particulate matter and inorganic acids, and blast furnaces also produce large amounts of CO₂ and NOx. Blast furnaces produce molten metal (cast iron) with a high carbon content (typically approx. 4% by weight) which is then transformed into steel in Basic Oxygen Furnaces (BOF). The use of synthesis gas produced outside the blast furnace, also using the coke oven (COG) and the blast furnace (BFG) gases, reduces the emissions of pollutants mentioned above and the production of greenhouse gases, in particular because the production and use of coke is reduced, and because COG and BFG quotas are reused that would otherwise be burned to produce thermal and electrical energy.

On the other hand, coke is not used in direct reduction (DR) processes of ferrous minerals. Here the reducing gas is typically produced from Natural Gas (GN) which can be directly fed to the DR reactors or can be transformed first into synthesis gas with steam-CO₂ reforming units. Direct Reduced Iron (DRI) produces iron sponges (Cold Direct Reduced Iron—CDRI, Hot Briquetted Iron—HBI, Hot Direct Reduced Iron—HDRI) which are then melted and transformed into steel typically in Electrical Arch Furnaces (EAF). The Smelting Reduction processes, on the other hand, do not use either coke or NG but use coal which is combusted with pure oxygen generating synthesis gas inside the reactors. This solution, like that of DR, has a lower environmental impact than the processes that use BF and their use is expanding. It is therefore understood that the technologies that use synthesis gas in the reduction processes of ferrous minerals constitute and will increasingly constitute an advantageous solution to reduce the environmental impact of these industrial activities. However, in these cases the production of synthesis gas, in order to be advantageous, must often lead to mixtures with a high CO content which can be obtained by feeding the reactors with mixtures with low S/C ratios and high CO₂/C ratios under conditions in which the known catalysts have a high thermodynamic affinity towards the reactions for the production of carbonaceous residues. Thermodynamic affinity which is reduced, as will be seen below, by the use of the catalysts according to the present invention.

### Preparation of Metal-Carbonyl Clusters

The preparation of a carbonyl derivative is usually carried out by reduction of the corresponding inorganic compound. The choice of reducing agent is the most critical aspect of this preparation, but if CO is used, no additional reducing agent may be needed. The oxidation products are CO₂ (DG° _{f}=−394 KJ mol⁻¹) or COCl₂ (DG° _{f}=−206 kJ mol⁻¹) if the starting material is a metal oxide or a metal chloride. Molecular hydrogen can also be used as a reducing agent in the presence of CO.

No solvent is used in the dry methods. In wet methods, an anhydrous organic solvent is employed, usually a hydrocarbon or an ether. Exceptionally, in the case of the carbonyl derivatives of Pt (II), Pd (II) and Au (I), thionyl chloride (SOCl₂) can be used as a solvent, since it provides the strictly anhydrous conditions for the survival of the reaction product. In some cases, water can also be used as a reaction medium, with or without the addition of a specific reducing agent. In the latter case, CO is the reducing agent and carbonate is the corresponding oxidation product.

Some preparation procedures reported in the literature usually require high temperatures (50-200° C.) and pressures (50-200 ATM). However, most recent preparation methods operate at room temperatures, or slightly higher, and atmospheric pressure.

In particular:
i) Rh₄(CO)₁₂ can be prepared from RhCl₃ and CO in a very wide range of pressures (PCO=1-20 MPa) often in the presence of a halogen acceptor, such as copper, silver, cadmium or zinc. The nature of the products depends on the temperature. At 50-80° C., the tetra-nuclear compound is mainly formed, while at 80-230° C. the preferred product is Rh₆(CO)₁₆. A detailed procedure for obtaining the cluster with an 80-90% yield at atmospheric pressure using RhCl₃·3H₂O salts is described in the article “Tri-m-Carbonyl-Nonacarbonyl-Tetra-Rhodium; Rh₄(CO)₉(pCO)₃”; S. Martinengo et Al.; Inorganic Syntheses, Volume 28, 1990, pages 243-245.
ii) Ir₄(CO)₁₂ can be prepared by carbonylation of iridium halides in the presence of a halogen acceptor (copper or silver), usually at high temperature and pressure. However, there are preparation methods that require a low P_{CO}, e.g. 0.1 MPa. Here the procedure described in the article “Dodeca-carbonyl-tera-Iridium: Ir₄(CO))₁₂”; S. Martinengo et Al.; Inorganic Syntheses, Volume 28, 1990, pages 245-248 is mentioned; which includes two steps. In the first step, the IrCl₃·3H₂O is transformed into [Ir(CO)₂Cl₂]⁻ with a high temperature carbonylation, and in the second step [Ir (CO)₂Cl₂]− is converted into Ir₄(CO)₁₂ at room temperature due to partial buffering of the acidity formed.
iii) Preparations of Ru₃(CO)₁₂ at CO atmospheric pressure have also been reported using the hydrated ruthenium (III) chloride RuCl₃·H₂O in 2-ethoxyethanol or iso-propanol. The “one-pot” procedure described in “Dodeca-carbonyl-tri-Ruthenium: Ru₃(CO)₁₂” di M. Fauré et al., in “Transition Metal Carbonyl Compounds; 2004”; pp. 110-115; https://doi.org/10.1002/0471653683.ch3” is ideal for the rapid conversion (3-4 h) under 1 atm of CO of moderate amounts of RuCl₃·3H₂O into Ru₃(CO)₁₂, with yields greater than 90%. In fact, it combines the advantages of simplicity, speed, high-efficiency and insensitivity to humidity, thus allowing the direct use of all commercial reagents as received.
iv) Co₂(CO)₈ can be prepared by carbonylation of cobalt (II) salts of organic or inorganic acids with synthesis gas at mild temperatures and high pressures (10-18 MPa) in a hydrocarbon solvent. However, there is a synthetic path that requires milder conditions and involves the formation of [Co(CO)₄], from which Co₂(CO)₈ can be obtained by controlled oxidation. The monometallic anion is prepared by carbonylation of an aqueous alkaline solution of cobalt (II) salt using carbon monoxide as a reducing agent at atmospheric pressure and room temperature. The finely divided cobalt, as obtained from any cobalt halides with Li/naphthalene in diethyl ether of ethylene glycol (1,2-diethoxyethane), is converted into Co₂(CO)₈ with good yields at 100° C. and 95 atm of pressure. Co₄(CO) 12 is the product of the thermal decarbonylation of Co₂(CO)₈.

### Preparation of Acetyl Acetonates

Metal acetylacetonates are coordination complexes derived from the acetylacetonate anion (CH₃COCHCOCH₃⁻) and metal ions, usually transition metals. The bidentate acetylacetonate ligand is often abbreviated to “acac”. Typically, both oxygen atoms bond to the metal to form a six-membered chelated ring. However, in some cases acac also binds to metals via the central carbon atom; this bonding mode is more common for third row transition metals such as platinum (II) and iridium (III). The simplest complexes have the formula M(acac)₃ and M(acac)₂. Many variations of acetylacetonate have also been developed with various substituents R and R′ instead of methyl (having the general formula R′COCH₂COR⁻), in which R and R′ can be the same or different and each contain up to 6 atoms of carbon. Many of these complexes are soluble in organic solvents, unlike their related metal halides. Here are some of the known acac compounds: Fe(acac)₃, Co(acac)₃, Ni(acac)₂ and [Ni(acac)_{2]3}, e Rh(acac)₃, Ru(acac)₃, Ir(acac)₃ e Ir(acac)(CO)₂, Pt(acac)₂. Pd(acac)₂.

A general method of synthesis is to treat a metal salt with acetylacetone (acacH)

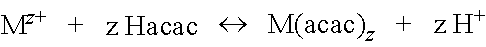

However, in some cases a carbonate salt of the transition metal can also be used as in the following reaction:

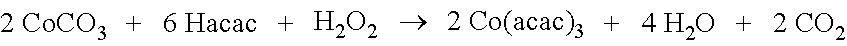

Solid-Liquid Reactions Between Organic Solutions of Rh₄(CO)₁₂, Ir₄(CO) 12, Ru₃(CO) 12 and Ni, Co, Fe, Rh, Ir, Ru, Pd, Pt Acac Complexes with Catalyst Supports

The solid-liquid reactivity of the n-hexane and THE solutions of the carbonyl clusters Rh₄(CO)₁₂, Ir₄(CO)₁₂, Ru₃(CO)₁₂, with polycrystalline MgO surfaces having a low surface area (about 10 m²/g), α-Al₂O₃, CeO₂, La₂O₃, ZrO₂ and TiO₂ have been extensively described above. In short, limiting the discussion to the α-Al₂O₃ support, the method produced mono-layers or less than a monolayer of M-O—Rh′(CO)₂, M-HIr₄(CO)₁₁, [M-O—Ru(CO)₂]n (n>2). See in this regard: “Reactivity of Ruthenium Carbonyls on Metal Oxide Surfaces: Effects of the Surface Acid-Base Chemistry”; S. Uchiyama, B. C. Gates; Inorganica Chimica Acta, 147 (1988) 65-70; and “Surface characterization of the Ru₃(CO)₁₂-Al₂O₃ system: I. Interaction with the hydroxylated surface”; A. Zecchina et Al., J. Catal., 74 (1982), pp. 225-239; https://doi.org/10.1016/0021-9517(82)₉₀₀₂₉-X.

It should also be noted that cluster disaggregation reactions in monometallic species are more effective on CeO₂ and TiO₂ surfaces and less effective on MgO and La₂O₃. In any case, drying under moderate vacuum conditions and/or mild heat treatments decompose the surface carbonyl species leaving bare metal atoms on the catalyst supports. However, it is also noted that the carbonylated materials obtained after drying are already active in the reactions of SR, SCR, CPO and SCT-CPO and are transformed during the initial reactions into final species of bare metal clusters on the surfaces of the catalyst.

Virtually all acac complexes soluble in organic solvents (e.g. MeOH, THF, CHCl₃) can react through liquid-solid interactions with the coordinatively unsaturated surface sites (c.u.s.) of the supports. As for the surface OH groups, there appears to be a correlation between the acid/base sensitivity of an acac complex and its reactivity towards these groups, i.e. acac complexes that are unstable in the presence of OH “react with basic OH and those sensitive to H⁺ react (to some extent) with acidic ones. See “Interaction of Transition-metal Acetylacetonates with y-Al, O, Surfaces”; J. A. Rob van Veen,” Gert Jonkers and Wim H. Hesselink, J. Chem. SOC., Faraday Trans. I, 1989, 85(2), 389413.

Some of these reactions, in the case of Al₂O₃ supports, can be represented with the following equations:

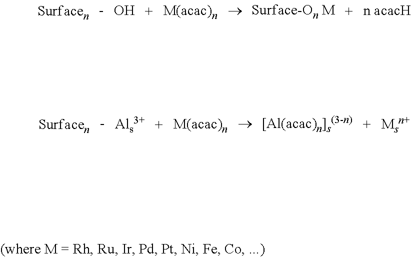

Incipient Wetness Impregnation (IWI) with Organic Solutions of Rh₄(CO)₁₂, Ir₄(CO)₁₂, Ru₃(CO) 12 and Ni, Co, Fe, Rh, Ru, Ir, Pt. Pd Acac Complexes of Catalyst Supports

In this case, concentrated organic solutions (e.g. N-hexane or THF) of the carbonyl clusters or other solutions (MeOH, THF, CHCl₃) of acac complexes are nebulized or left to drip onto the catalytic supports which are subsequently dried under vacuum at moderate temperatures, typically of between 25-100° C. The procedure is similar to the IWI method used with aqueous solutions of inorganic salts (e.g. Rh(NO)₃, Ir(NO)₃, Ru(NO)₃) but after impregnation, drying and heat treatments are carried out at much lower temperatures, or simply under vacuum, since the catalyst does not contain inorganic anionic substances that need to be thermally decomposed at high temperatures to obtain catalytic performance. It should be noted that the IWI method can cause both chemisorption phenomena (in which the organometallic compound reacts chemically with the active sites of the support by decomposing) and physiosorption phenomena (in which the organometallic compound is adsorbed by the support but does not transform chemically).

### Description of the Innovative Preparation Procedures of the Catalysts and of the New Products Thus Obtained

The new catalyst preparation processes and the new catalytic products are obtained through the appropriate combination of three preparation procedures; i.e.:
(A) IWI processes with aqueous solutions of inorganic salts;
(B) IWI processes using organic solutions of organometallic compounds;
(C) solid-liquid reactions between organic solutions of organometallic complexes and supports of catalysts dispersed in the same solvent.

The block diagrams describing these procedures are schematically represented in FIG. 1. Procedure (A) requires the highest calcination temperatures, which lead to emissions of polluting inorganic gaseous compounds that cannot be freely released into the atmosphere (for example NOx and halogens).

Procedure (B) does not require the calcination step but includes the preparation step of the organometallic compound and subsequently allows a chemical and/or physical interaction between the solid support and the organometallic compounds, leading to obtain catalysts that can also contain high quantities of catalytically active metals.

The procedure (C), like that (B), does not require the calcination step and includes the preparation step of the organometallic compound, but allows the selective deposition of the catalytically active metals through solid-liquid reactions which also allow obtaining depositions of monolayers or less than monolayers of catalytically active species on the supports of the catalysts.

Procedures (B) and (C) not only avoid NOx and halide emissions and do not require calcination steps, but are very effective in obtaining specific composition features on the surfaces of catalysts, particularly in cases where low quantities (i.e. monolayers lower than a monolayer) of the active metals and a high dispersion of the catalytic sites are useful. Furthermore, methods (B) and (C) allow the preparation of bimetallic or trimetallic catalysts with much simpler and more effective procedures.

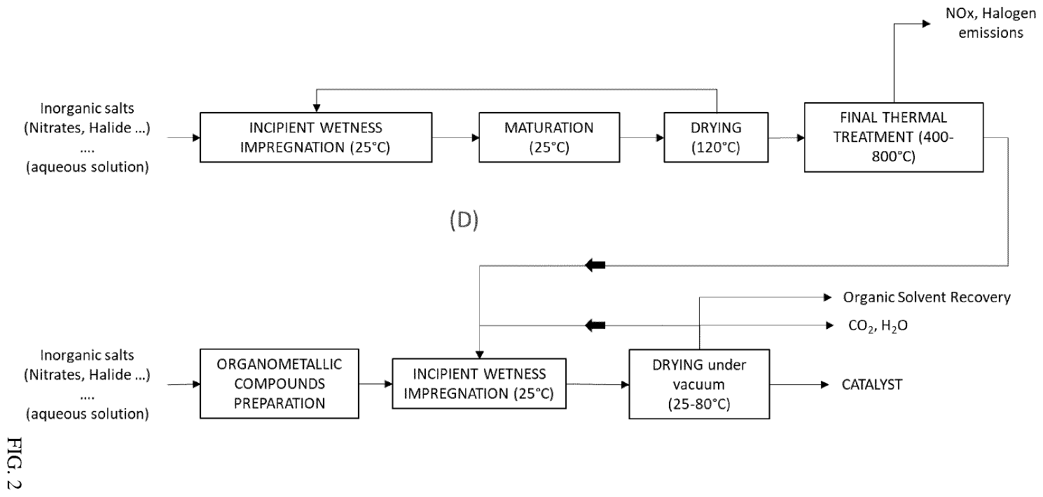

FIGS. 2, 3 and 4 include combinations of procedures (A)+(B)=(D) or (A)+(C)=(E) and (B)+(C)=(F) particularly useful for combining a deposition of relatively large quantities of transition metals, such as Ni, Fe, Co with method (A), and relatively small quantities of precious metals such as Rh, Ru, Ir with methods (B) or (C). The combination of procedures (B) and (C) allows the same possibilities given by the combinations of processes (A) and (B) or (A) and (C) but avoids the need for high temperature treatments and NOx emission or halide compounds and the formation of large surface metal aggregates with the same concentration of active metals.

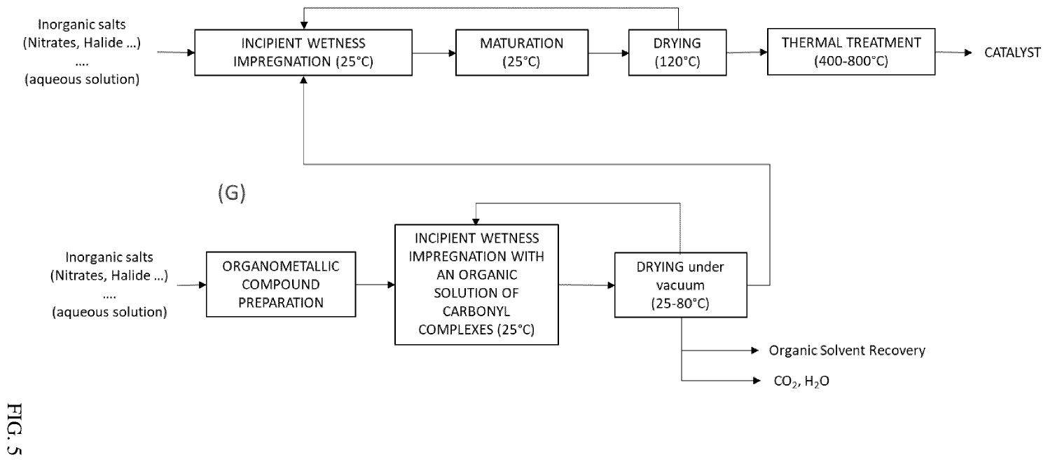

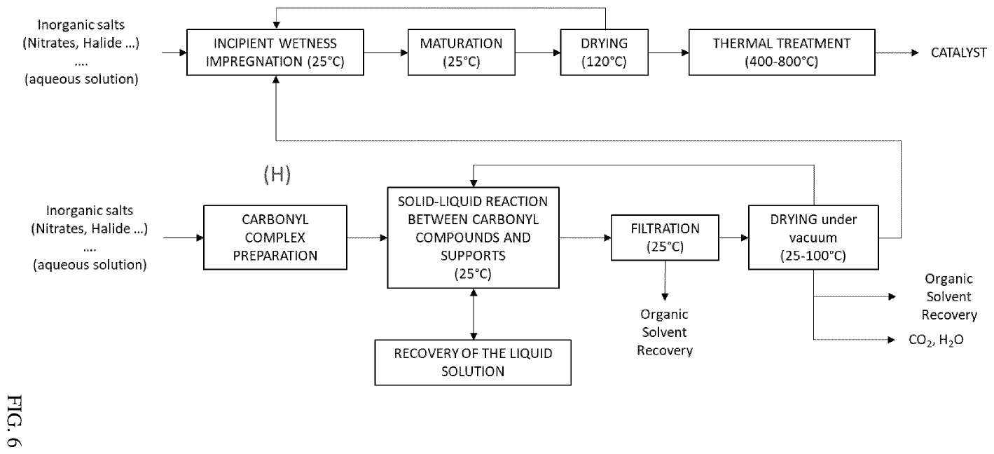

FIGS. 5 and 6 include other combination methodologies (B)+(A)=(G) and (C)+(A)=(H) useful for depositing comparable amounts of transition metals such as Ni, Fe, Co with the method (A) and precious metals, such as Rh, Ru, Ir, with methods (B) or (C), with the possibility of also producing metal alloys on the surfaces of the catalysts.

These preparatory methods can be used with supports of catalysts in powder form, in the form of pellets, or with monolith supports or with any other form of structured support. The latter, as already mentioned, are particularly useful for reducing pressure drops across the catalytic beds. In fact, it has been found that the pressure drops obtained with the use of structured catalysts can be two orders of magnitude lower than those obtained through packed beds. Furthermore, the monolithic supports can also reduce the radial and axial temperature gradients, by virtue of the greater effective thermal conductivity and the regularity of the internal path, which allows operating in a laminar regime.

Cordierite, a mixture of Mg, Si and Al oxides, extruded as a monolith for car exhaust gas treatments, is a commonly used high-temperature structured support, see in this regard “Nano-Array Integrated Structured Catalysts: A New Paradigm upon Conventional Wash-Coated Monolithic Catalysts?”; Weng, J.; Lu, X.; Gao, P.-X. Catalysts 7(2017) pp. 253-280. Other monolithic ceramic materials have a foam structure composed of different oxides, for example Al₂O₃ and ZrO₂, nitrides, for example Si₃N₄, borides for example BN and carbides, for example SiC. Furthermore, monolithic metallic supports, such as FeCrAl alloys, are also used when it is advantageous to increase the conductive heat transfer capacity inside the catalytic bed, see in this regard: “FeCrAl as a Catalyst Support”; Gianluca Pauletto, Angelo Vaccari, Gianpiero Groppi, Lauriane Bricaud, Patricia Benito, Daria C. Boffito, Johannes A. Lercher, and Gregory S Patience; Chemical Reviews, 2020; https://dx.doi.org/10.1021/acs.chemrev.0c00149.

These structured catalysts are used in a number of reactions. The first applications involved the treatment of exhaust gases, the elective catalytic reduction (SCR) of NOx, the destruction of volatile organic compounds (VOCs) and catalytic combustion. Other reactions are currently being developed including SR and SCR with steam and CO₂ (SCR) of natural gas or methanol, partial catalytic oxidation (CPO) of natural gas, the Water Gas Shift (WGS) process, the Fischer-Tropsch synthesis (FT), the oxidative coupling reaction of methane (OCM).

The most recent methods for preparing catalysts on FeCrAl alloy supports are often laborious and time consuming. These are methods that include a series of steps such as, for example, the growth of a layer of Al₂O₃ on the external surface of the FeCrAl alloy, the preparation of g-alumina powders, possibly modified with a stabilizer, their impregnation with aqueous solutions containing salts of noble metals, the calcination in air, the reduction with hydrogen, the preparation of a suspension of the noble metal-alumina powder, the repeated immersion and drying of the FeCrAl alloy support in the suspension, and the final calcination, see in this regard: “Premixed metal fibre burners based on a Pd catalyst”; I. Cerri, M. Pavese, G. Saracco, V. Specchia; Catal. Today 83 (2003); 19-31.

Other methods include the preparation of hydrotalcite compounds containing noble metals, followed by calcination and spontaneous deposition through a galvanic displacement or electrodeposition reaction; see in this regard: “Preparation of 3D) electrocatalysts and catalysts for gas-phase reactions, through electrodeposition or galvanic displacement”; M. Musiani, S. Cattarin, S. Cimino, N. Comisso, L. Mattarozzi, L. Va zquez-Go′mez, E. Verlato; J. Appl. Electrochem.; 45(2015) pp. 715-725.DOI 10.1007/s10800-015-0808-1.

In the method according to the invention, the use of organic solutions of organometallic compounds such as carbonyl clusters and/or acetyl acetonates can be applied in particular in the deposition of noble metal species both on ceramic supports, e.g. cordierite, and on metallic supports, e.g. FeCrAl alloys, using IWI methods and the solid-liquid reaction methods described above. The use of these methods allows reducing the complexity of drying and calcination treatments and reductive treatments, which can be completely avoided, and also, the achievement of improvements in the quality of the catalyst properties with respect to the distribution and grafting of the noble metal, with the effect of improving its performances and lifetime.

Similarly, the described methodology can be applied to wall reactors, which contain walls coated with catalytic species. In some cases, these reactors have been designed to couple an exothermic reaction, such as combustion, on one side of the wall, while carrying out an endothermic reaction on the other side; see in this regard: “Thermal and hydrothermal stability of a metal monolithic anodic alumina support for steam reforming of methane”; Yu Guo, Lu Zhou, Hideo Kameyama; Chem. Eng. J. 168 (2011) 341-350; doi:10.1016/j.cej.2011.01.036. In this case, the heat released by the exothermic reaction is transmitted directly to the other side of the wall to drive the endothermic reaction; this configuration greatly reduces the heat transfer resistance of the boundary layer and thus increase the speed and efficiency of the heat transfer to the environment in which the catalytic reactions take place. Recently, also electrified reactors of this type have been proposed for the steam reforming (SR) of methane; see in this regard: Electrified methane reforming: A compact approach to greener industrial hydrogen production”; Wismann et al., Science 364 (2019) 756-759; e “Thermal and hydrothermal stability of a metal monolithic anodic alumina support for steam reforming of methane”; Yu Guo, Lu Zhou, Hideo Kameyama; Chemical Engineering Journal 168 (2011) 341-350; doi:10.1016/j.cej.2011.01.03.

Preparation methods using organometallic compounds are particularly suitable for these applications as well.

In general, it is reported that the methods described allow producing catalysts with highly dispersed metal species (dispersion at 100%) and are therefore particularly convenient if one wishes to use catalytic systems with a low content of active metals and, in particular, of noble metals.

Furthermore, these catalysts showed greater activity towards SR, CR, SCR in the presence of large quantities of CO₂ and catalytic partial oxidation (CPO) even at low contact time (SCT-CPO). In these cases, the catalysts prepared using organometallic precursors have shown a higher intrinsic activity than the known materials and good reactivity features towards synthesis gas production reactions in reaction conditions in which there is a high thermodynamic affinity towards carbon species formation, e.g., conditions in which low values of the S/C ratios are used and therefore with low quantities of steam in the reagent mixtures.

In fact, it has been found that the catalysts prepared through the methods that use organometallic precursors of elements such as Ni, Co, Fe and relatively low quantities of noble metals such as Rh, Ir, Ru, allow carrying out reactions of SR, SCR of CPO and of SCT-CPO in conditions in which the catalysts prepared with the known methods are deactivated due to the production of carbon residues.

The invention is now illustrated with reference to the following examples, provided by way of non-limiting example.

### EXAMPLES

### Example 1 (Comparison)

A Ni/α-Al₂O₃ sample was obtained by means of the impregnation method with incipient wettability (IWI) and with subsequent drying and calcination treatments according to the scheme represented in the scheme of FIG. 1A. The incipient wettability impregnation was carried out using an aqueous solution of Ni (NO₃)₂(Ni 27% wt) made to drop on a sample of α-Al₂O₃ consisting of spheres of 2 mm in diameter, having a surface area of 11 m²/g and a porosity of 0.57 cm³/g (average pore diameter 350 A). The surface area was measured according to the Brunauer, Emmet and Teller (BET) method (J. Am. Chem. Soc. 1938, 60 (2), 309) with a commercial device, while mercury porosimetry and the measurement of physisorption of gaseous species (N₂) were used for the measurements of porosity and pore diameter. The sample was dried at 120° C., with a heating rate of 3 ºC/min, for 2 hours. The IWI and drying procedures were repeated twice, after which the sample was heated to 750° C., with a heating rate of 3ºC/min, for two hours to decompose the nitrate salts.

X-ray diffraction (XRD) and scanning electron microscopy (SEM) measurements revealed that the Ni species were present as NiO clusters mostly ranging in size from 15-25 nm.

The material obtained, containing 2.9% by weight of Ni, required a reduction treatment with a flow of H₂+N₂, containing 10% of H₂ v/v, carried out by increasing the temperature between 25-500° C. with a heating rate of 3ºC/min and leaving the catalyst at 500° C. for 3 hours. This treatment transformed the oxidic species of Ni on the surface of the α-Al₂O₃ support into aggregates of metallic Ni generating the catalytically active sites for the production of synthesis gas.

### Example 2 (Comparison)

A sample of Rh/α-Al₂O₃ was obtained through the IWI process and the drying and calcination heat treatments according to the scheme of FIG. 1A, using an aqueous solution containing Rh(NO₃)₂ (Rh 12.5% by weight) dropped onto a sample of α-Al₂O₃ consisting of spheres with a diameter of 2 mm, a surface area of 11 m²/g and a porosity of 0.57 cm³/g, with an average diameter of pores of 350 A. After the impregnation, the material was dried at 120° C., with a heating rate of 3ºC/min, for 2 hours. The IWI and drying procedures were repeated three times, after which the sample was heated to 750° C., with a heating rate of 3ºC/min and left at the maximum temperature reached for two hours to decompose the nitrate salts. The final material, cooled to room temperature, contained 1.0% by weight of Rh. XRD and SEM measurements revealed that Rh species were present as surface Rh₂O₃ clusters, ranging in size from 10-50 nm. Before use in synthesis gas production reactions the material was reduced with a flow of H₂+N₂, containing 10% of H₂ v/v, increasing the temperature between 25-500° C. with a heating speed of 3° C./min and leaving the catalyst at 500° C. for 3 hours.

### Example 3 (Comparison)

A sample of Rh—Ni/α-Al₂O₃ was obtained through IWI procedures and drying and calcination heat treatments according to the scheme described in FIG. 1A, using two aqueous solutions, the first of Ni(NO₃)₃ (Ni 27% by weight) and the second of Rh(NO₃)₂ (Rh 12.5%% by weight), which were dripped onto a sample of α-Al₂O₃ consisting of spheres with a diameter of 2 mm, surface area of 11 m²/g and porosity of 0.57 m³/g, with an average pore diameter of 350 A. The volumes of the solutions of Ni(NO₃)₃ and Rh (NO₃)₃ were regulated in order to obtain a solution having a Rh/Ni ratio of 0.25 g/g and 0.14 mol/mol. The sample was dried at 120° C., with a heating rate of 3° C./min, for 2 hours and the IWI and drying procedure were repeated twice, after which the sample was heated to 750° C. with a heating speed of 3ºC/min for two hours to decompose the nitrate salts.

The final material cooled to room temperature at 10° C./min, contained 2.6% by weight of Ni and 0.7% by weight of Rh. XRD and SEM measurements revealed that Ni species were present as NiO species having for the most part sizes between 10-15 nm, and that Rh species were present as surface Rh₂₀₃ clusters mostly having dimensions difficult to estimate. Before use in synthesis gas production reactions the material was reduced with a flow of H₂+N₂, containing 10% of H₂ v/v, increasing the temperature between 25-500° C. with a heating speed of 3° C./min and leaving the catalyst at 500° C. for 3 hours.

### Examples 4-6

Samples of Rh, Ru, Ir deposited on α-Al₂O₃ supports (with the same features described in Examples 1-3) were prepared, obtaining catalysts containing 1% by weight of the noble metals. The procedure followed is described in the diagram of FIG. 1B and included an IWI step carried out by dripping a solution of anhydrous THF containing 10% by weight of the noble metals Rh₄(CO)₁₂ (Example 4), Ru₃(CO)₁₂ (Example 5) or Ir₄(CO)₁₂ (Example 6) on the supports of α-Al₂O₃. More specifically, the step of impregnation with incipient wettability was carried out in a rotating vessel (20 rpm). The noble metal clusters reacted with the surfaces producing a monolayer of surface species, mainly M (I) di-carbonyls (M=Rh, Ru, Ir), up to the consumption of the coordinatively unsaturated surface sites (cus), while the excess metal clusters accumulated on the surface as physically adsorbed species. This information was obtained by carrying out diffuse reflectance infrared spectra (DRIFT) on the samples thus obtained. The solvent was removed under a slight vacuum and the materials were heated in air reaching 150° C. with a heating rate of 3ºC/min. During the heat treatment, the carbonyl clusters decomposed producing mainly CO₂ and H₂O species, leaving small Rh aggregates on the surfaces of the α-Al₂O₃. The materials thus obtained were used in the production reactions of synthesis gas (SR, SCR, CPO, SCT-CPO) as such without requiring calcination and reduction in flow treatments of mixtures containing hydrogen.

### Examples 7-12

Samples containing Rh were prepared at room temperature by dripping a red solution of Rh₄(CO)₁₂ (Rh 5% by weight) in n-hexane in a suspension of oxides pelletized in the same solvent, according to the scheme of FIG. 1C. The pellets had a particle diameter of 2 mm and a low surface area, ranging from 5 to 20 m²/g. The pellets consisted of: i) α-Al₂O₃(Example 7), ii) spinel oxides MgAlOx (Example 8), iii) CeO₂ (Example 9), La₂O₃ (Example 10), iv) ZrO₂·3Y₂O₃·CeO₂ (Examples 11-12). The solid-liquid reaction between the solutions containing the organometallic compounds and the oxidic surfaces was followed through the de-coloration of the solutions containing the carbonyl clusters. After two hours, the solid was isolated by filtration and dried under vacuum at room temperature. The DRIFT spectra (Diffuse Reflectance Infrared Fourier Transform spectroscopy) of the samples thus obtained revealed stretching absorption bands of the carbonyl groups at 2085 and 2008 cm-1 for the Rh/MgAOₓ sample and at 2090 and 2010 cm-1 for the Rh/α-Al₂O₃ sample. These bands were assigned to Rh (I)(CO)₂ surface species formed through an oxidative disaggregation of the rhodium cluster involving the OH groups at the surface of the polycrystalline oxides.

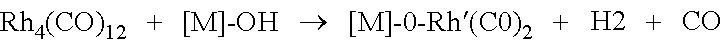

In the IR spectra of the Rh samples deposited on the supports of Ce0₂, ZrO₂·3Y₂O₃·CeO₂ and ZrO₂·3Y₂O₃, peaks at 2095 and 2010 cm⁻¹ assigned to the same Rh monometallic species were found, and a shoulder near 2110 cm-1 assigned to a carbonyl complex with rhodium atoms in an oxidation state greater than +I. The catalysts did not require any further heat treatment prior to their use in synthesis gas production reactions.

The quantity of Rh adsorbed by La₂O₃ and ZrO₂·3Y₂O₃ corresponded to 0.15% by weight. The Rh adsorbed on ZrO₂·3Y₂O₃·CeO₂ corresponded to 0.2%. The content of Rh in the samples of MgAlOx corresponded to 0.5% by weight, while the amount of Rh in the samples of α-Al₂O₃ and CeO₂ corresponded respectively to 0.3 and 0.4% by weight. These Rh content values and spectroscopic information indicated that the method followed produced 100% of the Rh dispersion on each sample, and that their surfaces contained less than one Rh monolayer.

### Example 13

The preparation procedure (D) described in FIG. 2 was adopted, initially producing a sample of Ni/α-Al₂O₃ obtained by IWI using, as in Examples 1 and 3, an aqueous solution of Ni(NO₃)₂ (Ni 27% by weight), which was dripped onto spheroidal samples of α-Al₂O₃ having a diameter of 2 mm, a surface area of 11 m²/g and a porosity of 0.57 cm³/g. The impregnation step was repeated twice and each impregnation step was followed by a heat treatment at 120° C. of 2 hours, as described in Examples 1 and 3. The sample was then calcined at 750° C. for 2 hours. After cooling, the material obtained was treated again through an IWI phase using a solution of Rh₄(CO)₁₂ in THF, as in Example 4. The last impregnation step was followed by a vacuum drying step and a heat treatment in air at 120° C. for two hours, with a heating rate of 3° C./min, as described in Example 4. The final catalyst contained 2.9% by weight of Ni and 0.9% by weight of Rh and was used in the synthesis gas production reactions without any further reduction step.

### Example 14

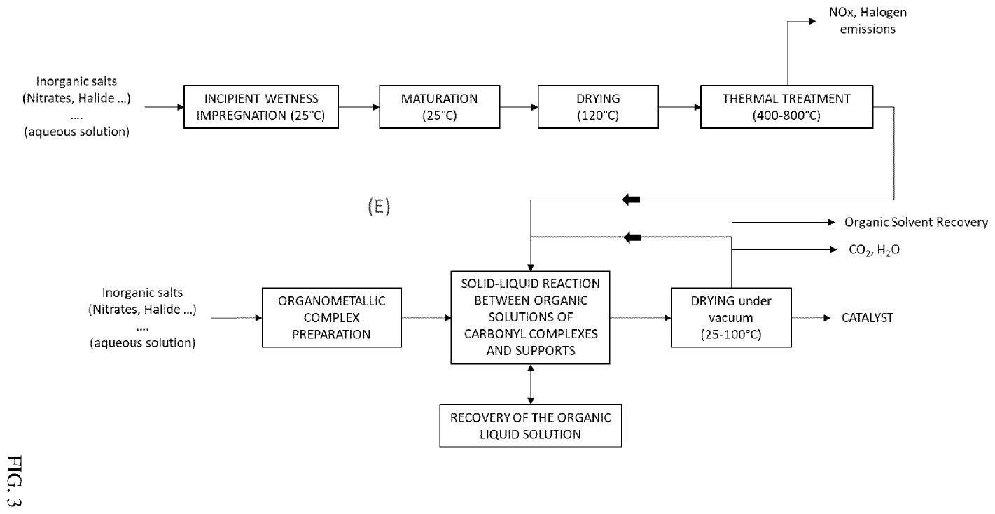

The preparation procedure (E) described in FIG. 3 was adopted, initially producing a sample of Ni/α-Al₂O₃ by IWI using, as in Example 13, an aqueous solution of Ni(NO₃)₂ (Ni 27% by weight) dripped onto spheroidal samples of α-Al₂O₃ having a diameter of 2 mm, a surface area of 11 m²/g and a porosity of 0.57 cm³/g. The impregnation step was repeated twice and each impregnation step was followed by a heat treatment at 120° C. of 2 hours, as described in Example 13. The sample was then calcined at 750° C. for 2 hours and after cooling it was immersed in a solution of Rh₄(CO)₁₂ in n-hexane, which was chemically adsorbed, as in Examples 7-12, reacting with the coordinatively unsaturated sites (cus) of α-Al₂O₃/NiO surfaces. After 2 hours, the solid was isolated by filtration and dried under vacuum at room temperature. No other heat or reductive treatment was required to use the catalyst in synthesis gas production reactions. The final catalyst contained 2.9% by weight of Ni and 0.5% by weight of Rh.

### Example 15

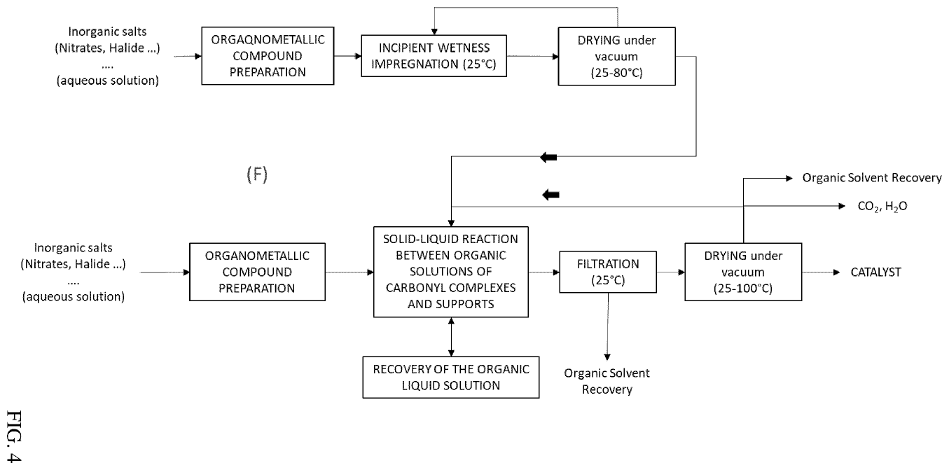

The preparation procedure (F) described in FIG. 4 was adopted, using the α-Al₂O₃ spheres described in the previous Examples 1-14 for the initial IWI step but using a solution of Ni(acac)₃ in THF] A sample was obtained which was dried under vacuum and subsequently heated to 150 ºC for 2 hours, with a heating rate of 3° C./min. After cooling, the spheres were immersed in a solution of Rh₄(CO)₁₂ in n-hexane, allowing solid-liquid reactions between the coordinatively unsaturated sites (cus) of the surfaces of α-Al₂O₃ containing Ni and the carbonyl clusters. After 2 hours, the solid was isolated by filtration and dried under vacuum at room temperature. No other thermal or reductive treatment was carried out before using the catalyst thus produced which contained 2.7% by weight of Ni and 0.5% by weight of Rh, in the synthesis gas production reactions.

EXAMPLE 16. The preparation procedure (F and D) described in FIGS. 4 and 2 were adopted, using the α-Al₂O₃ spheres described in the previous Example 15 for the initial IWI step using a solution of Ni(acac)₃ in THF]. The sample which was obtained was dried under vacuum and subsequently heated to 150° C. for 2 hours, with a heating rate of 3 ºC/min. After cooling, the spheres were immersed initially in a solution of Rh₄(CO)₁₂ in n-hexane, allowing solid-liquid reactions between the coordinatively unsaturated sites (cus) of the surfaces of α-Al₂O₃ containing Ni and the carbonyl clusters. After 2 hours, the solid was isolated by filtration and dried under vacuum at room temperature. The dried sample was then treated with a IWI procedure by utilising a n-hexane solution of Ru₃(CO)₁₂. No other thermal or reductive treatment was carried out before using the catalyst thus produced which contained 2.6% by weight of Ni and 0.4% by weight of Rh and 0.3% wt of Ru, in the synthesis gas production reactions

EXAMPLE 17. The preparation procedure (F and D) described in FIGS. 4 and 2 were adopted, using the α-Al₂O₃ spheres described in the previous Example 15 and 16 for the initial IWI step using a solution of Ni(acac); in THF. The sample which was obtained was dried under vacuum and subsequently heated to 150° C. for 2 hours, with a heating rate of 3° C./min. After cooling, the spheres were immersed initially in a solution of Rh₄(CO)₁₂ in n-hexane, allowing solid-liquid reactions between the coordinatively unsaturated sites (cus) of the surfaces of α-Al₂O₃ containing Ni and the carbonyl clusters. After 2 hours, the solid was isolated by filtration and dried under vacuum at room temperature. The dried sample was then treated with a IWI procedure by utilising a n-hexane solution of Ir₄(CO)₁₂. No other thermal or reductive treatment was carried out before using the catalyst thus produced which contained 2.6% by weight of Ni and 0.4% by weight of Rh and 0.3% wt of Ru, in the synthesis gas production reactions EXAMPLE 18. The preparation procedure (F and D) described in FIGS. 4 and 2 were adopted, using the α-Al₂O₃ spheres described in the previous Example 15-17 for the initial IWI step using a solution of Ni(acac)₃ and Co(acac) in THF. The sample which was obtained was dried under vacuum and subsequently heated to 150° C. for 2 hours, with a heating rate of 3° C./min. After cooling, the spheres were immersed initially in a solution of Rh₄(CO)₁₂ in n-hexane, allowing solid-liquid reactions between the coordinatively unsaturated sites (cus) of the surfaces of α-Al₂O₃ containing Ni and the carbonyl clusters. After 2 hours, the solid was isolated by filtration and dried under vacuum at room temperature. No other thermal or reductive treatment was carried out before using the catalyst thus produced which contained 2% by weight of Ni 1% wt of Co and 0.5% by weight of Rh, in the synthesis gas production reactions.

### Examples 19-36: Reactivity Test to Reforming with Co₂ and Partial Catalytic Oxidation

The compositions of the catalysts and the main features observed during the reactivity tests in the syngas production reactions by CO₂ reforming and CPO reactions are reported in Table 1.

### CO₂ Reforming Test

Each test lasted 100 hours and was carried out at 0.5 MPa in a plug-flow reactor having an internal diameter of 15 mm while the catalytic bed had a length of 100 mm. The hourly space velocity values of the gas [GHSV=(NL x hours⁻¹ of reagent)/L CAT] were adjusted to 5,000 hours¹ by feeding the reactor with a mixture of CH₄/CO₂=1/1 v/v preheated. The electrical preheating and reactor heating were adjusted to maintain inlet temperatures in the first layer of the catalytic bed of 750° C. The catalysts prepared in Examples 1-3 were pre-reduced with a heating cycle between 25 and 400° C. in a flow of H₂₊₉₀% N₂ at 10% with a duration of approx. 5 hours. The Ni-based catalysts prepared as in EXAMPLE 1 were deactivated by the reaction of formation of carbonaceous residues in less than an hour. The Ni—Rh catalyst prepared as in EXAMPLE 3 was partially deactivated and within the 100 hours of reaction after being discharged, it contained 10.4% by weight of carbon residues. In contrast, the catalyst containing similar amounts of Ni—Rh metals prepared using organometallic carbonyl compounds showed much lower affinity for coke forming reactions (see EXAMPLES 13, 14, 15 and Table 1). It should be noted that the catalysts containing Rh (0.1-0.5% of Rh deposited on α-Al₂O₃ and MgAlOx from organometallic precursor) as in EXAMPLES 4-15, did not deactivate although they were not activated with a pre-treatment of reduction in H₂+N₂ and they maintained reactivity features with equilibrium approach values lower than 5° C.

In this regard, it is reported that the approach temperature to equilibrium for the CO₂ reforming and Steam Reforming reactions (ΔT_{approach CR} and ΔT_{approach SR}) are defined as the differences between the actual temperature of the gas leaving the reactor (Tg) and the temperature at which the experimental composition of the gas leaving the reactor would be at equilibrium (T_{eq}).

$$\begin{matrix}{CH}_{4} + {CO}_{2} = 2 CO + 2 {H}_{2} & DH {°}_{298} = 247 kJ / mole & ( CR ) \\ {CH}_{4} + {H}_{2} O = CO + 3 {H}_{2} & DH {°}_{298} = 206 kJ / mole & ( SR ) \\ Δ {T}_{approach SR} = {T}_{g} - {T}_{eq SR} & & \\ Δ {T}_{approach CR} = {T}_{g} - {T}_{eq SR} & & \end{matrix}$$

### SCT-CPO Low Contact Time Catalytic Partial Oxidation Test

The reactivity tests lasted 100 hours and were carried out at 0.5 MPa and reactor outlet temperatures between 750-850° C., feeding reagent mixtures containing CH₄/O₂/H₂O=2/1.2/1 v/v o CH₄/O₂/CO₂=2/1.2/1 v/v and GHSV=85,000 h⁻¹. The reagent mixture was preheated to 150° C. before entering the catalyst bed, which was designed with a truncated cone shape as described in WO97/37929 and dx.doi.org/10.1021/ie402463m, Ind. Eng. Chem. Ris. 2013, 52, 17023-17037. In particular, the inlet diameter of the truncated cone corresponded to 5 mm, the outlet diameter corresponded to 25 mm and the height of the truncated cone corresponded to 30 mm. Deactivation phenomena due to the formation of carbon residues are highlighted in EXAMPLES 1 and 3 and to a lesser extent in EXAMPLES 10 and 11 (see Table 1). It should be noted that in some reactivity tests the approach to equilibrium temperatures showed negative values, indicating that the reactions took place in local areas in which the surface temperatures of the catalysts were higher than the gaseous outlet temperatures, as discussed in dx.doi.org/10.1021/ie402463m, Ind. Eng. Chem. Ris. 2013, 52, 17023-17037.

TABLE 1
Results of CO2 reforming and partial catalytic oxidation (CPO) reactivity tests

| | Method of | Support | Metal | Pretreatment | Formation of coke |
|---|---|---|---|---|---|
| | preparation | oxide | content p. | (H2 + N2) | CO2 reforming |
| Example 1 | (A) FIG. 1 | α-Al₂O₃ | Ni (2.92% w.) | YES | YES (massive) |
| Example 2 | (A) FIG. 1 | α-Al₂O₃ | Rh (1.11% w.) | YES | NO |
| Example 3 | (A) FIG. 1 | α-Al₂O₃ | Ni (2.62% w.)-Rh (0.71% w.) | YES | YES (10.4% w. in 100 hours) |
| Example 4 | (B) FIG. 1 | α-Al₂O₃ | Rh (1.02% w.) | NO | NO |
| Example 5 | (B) FIG. 1 | α-Al₂O₃ | Ru (1.10% w.) | NO | YES (1.5% w. after 100 hours) |
| Example 6 | (B) FIG. 1 | α-Al₂O₃ | Ir (1.05% w.) | NO | NO |
| Example 7 | (C) FIG. 1 | α-Al₂O₃ | Rh (0.35% w.) | NO | NO |
| Example 8 | (C) FIG. 1 | MgAlOₓ (spinel) | Rh (0.52% w.) | NO | NO |
| Example 9 | (C) FIG. 1 | CeO₂ | Rh (0.46% w.) | NO | NO |
| Example 10 | (C) FIG. 1 | La₂O₃ | Rh (0.15% w.) | NO | YES (4.2% w. after 100 hours) |
| Example 11 | (C) FIG. 1 | ZrO₂•3Y₂O₃ | Rh (0.15% w.) | NO | YES (3.8% w. after 100 hours) |
| Example 12 | (C) FIG. 1 | ZrO₂•3Y₂O₃•CeO₂ | Rh (0.25% w.) | NO | YES (1.8% w. after 100 hours) |
| Example 13 | (D) FIG. 2 | α-Al₂O₃ | Ni (2.93% w.)-Rh (0.91% w.) | NO | YES (0.5% w. after 100 hours) |
| Example 14 | (E) FIG. 3 | α-Al₂O₃ | Ni (2.91% w.)-Rh (0.51% w.) | NO | NO |
| Example 15 | (F) FIG. 4 | α-Al₂O₃ | Ni (2.81% w.)-Rh (0.63% w.) | NO | NO |
| Example 16 | (D, F) | α-Al₂O₃ | Ni (2.61% wt)-Rh (0.42% | NO | NO |
| | FIGS. 2, 4 | | wt-Ru (0.32%) | | |
| Example 17 | (D, F) | α-Al₂O₃ | Ni (2.61% wt)-Rh (0.42% | NO | NO |
| | FIGS. 2, 4 | | wt)-Ir (0.35%) | | |
| Example 18 | (D, F) | α-Al₂O₃ | Ni (2.15% wt)-Co (1.3%)-Rh | NO | NO |
| | FIGS. 2, 4 | | (0.53% wt) | | |

| | | ΔT app. at Eq. (Run start-Run end) | |
|---|---|---|---|
| | Formation of coke | CO2 reforming | CPO |
| | CPO | (ΔT CR) | (ΔT CR/ΔT SR) |
| Example 1 | YES (massive) | — | — |
| Example 2 | NO | 9° C.-10° C. | (−1° C./−2° C.)-(−1° C./−2° C.) |
| Example 3 | YES (5.2% w. after 100 hours) | 12° C.-15° C. | (3° C./5° C.)-(10° C./15° C.) |
| Example 4 | NO | 6° C.-7° C. | (−3° C./−5° C.)-(−3° C./−5° C.) |
| Example 5 | NO | 7° C.-9° C. | (−4° C./−5° C.)-(−1° C./−2° C.) |
| Example 6 | NO | 7° C.-7° C. | (−2° C./−3° C.)-(−2° C./−3° C.) |
| Example 7 | NO | 6° C.-7° C. | (−4° C./−8° C.)-(−4° C./−8° C.) |
| Example 8 | NO | 5° C.-6° C. | (−10° C./−15° C.)-(−10° C./−15° C.) |
| Example 9 | NO | 8° C.-9° C. | (4° C./5° C.)-(4° C./5° C.) |
| Example 10 | YES (1.5% w. after 100 hours) | 8° C.-11° C. | (10° C./9° C.)-(15° C./10° C.) |
| Example 11 | YES (2.0% w. after 100 hours) | 9° C.-12° C. | (12° C./9° C.)-(15° C./12° C.) |
| Example 12 | YES (1.8% w. after 100 hours) | 9° C.-11° C. | (10° C./7° C.)-(12° C./10° C.) |
| Example 13 | NO | 5° C.-7° C. | (−5° C./−10° C.)-(−5° C./−10° C.) |
| Example 14 | NO | 5° C- 6° C. | (−15° C./−20° C.)-(−15° C./−20° C.) |
| Example 15 | NO | 4° C.-5° C. | (−25° C./−30° C.)-(−25° C./−30° C.) |
| Example 16 | NO | 2° C. | (−30° C./−35° C.)-(−25° C./−30° C.) |
| Example 17 | NO | 3° C. | (−32° C./−35° C.)-(−24° C./−31 C.) |
| Example 18 | NO | 1° C. | (−30° C./−33° C.)-(−23° C./−29 C.) |

1-11. (canceled)

12. A method for preparing a catalyst for chemical processes comprising catalytic species, the catalytic species comprising a transition metal deposited on a support, the method comprising:
a) preparing a solution in an organic solvent of an organometallic compound of the transition metal forming the catalytic species and contacting it with the support, in which the organometallic compound is selected among the metal-carbonyls and complexes with organic ligands of the transition metal, wherein the support comprises one or more of: inorganic oxides; nitrides; oxy-nitrides; carbides; borides; and metal compounds on a surface of which oxidic structures are formed;
b) depositing the solution of the organometallic compound of the transition metal on the surface of the support with a chemisorption or physisorption process, wherein the depositing is carried out:
by contacting the solution of the organometallic compound of the transition metal using an incipient wetness impregnation of the support with the solution of the organometallic compound of the transition metal, or
by dispersing the support in the solution of the organometallic compound of the transition metal;
c) removing the organic solvent of the solution of the organometallic compound of the transition metal deposited on the surface of the support, and totally or partially decomposing the organometallic compound of the transition metal remaining on the surface of the support by effect of at least one heat treatment, the heat treatment being preceded by separation of the support from the solution of the organometallic compound of the transition metal, whereby one or more catalytic species of said transition metal are deposited on the support;
wherein before the contacting in step a) of the solution of the organometallic complex of the transition metal with the support, a first deposition of the transition metal is carried out on the support by impregnating the support with an aqueous solution of an inorganic salt or and organic solution of an organometallic complex of the transition metal, followed by drying and heating until decomposition of the inorganic salt or the organometallic complex, and deposition of the transition metal on the support.

13. The method of claim 12, wherein the transition metal comprises one or more transition metals, or compounds of transition metals.

14. The method of claim 13, wherein step a) is carried out with organic complexes of transition metals comprising Rh, Ru, and/or Ir.

15. The method of claim 12, wherein the metal-carbonyls comprise one or more of: Rh₄(CO)₁₂; Rh₆(CO)₁₆; Ru₃(CO)₁₂; Ir₄ (CO)₁₂; Fe₂(CO)₉; Fe₃(CO)₁₂; CO₂(CO)₈; Co₄(CO)₁₂; and/or Co₆(CO)₁₆.

16. The method of claim 12, wherein the organometallic compound with organic ligands of the transition metal is a complex in which the metal comprises one or more of: Co; Fe; Ni; Rh; Ru; Ir; Pt; and/or Pd, and in which the ligand is the RCOCHCOR′-group, where R and R′ can be the same or different and are C1-C6 alkyl groups.

17. The method of claim 12, wherein the support is in the form of pellets or in the form of a monolithic structure and comprises one or more of: MgO; α-Al₂O₃; MgAlOx; CeO₂; La₂O₃; ZrO₂; TiO₂; perovskites; cordierite; and FeCrAl alloys.

18. A catalyst for chemical processes comprising catalytic species, the catalytic species comprising a transition metal deposited on a support comprising one or more of: inorganic oxides; nitrides; oxy-nitrides; carbides; borides; and metal compounds on a surface of which oxidic structures are formed, the catalyst obtained by:
a) preparing a solution in an organic solvent of an organometallic compound of the transition metal forming the catalytic species and contacting it with the support, in which the organometallic compound is selected among the metal-carbonyls and complexes with organic ligands of the transition metal;
b) depositing the solution of the organometallic compound of the transition metal on the surface of the support with a chemisorption or physisorption process, wherein the depositing is carried out:
by contacting the solution of the organometallic compound of the transition metal using an incipient wetness impregnation of the support with the solution of the organometallic compound of the transition metal, or
by dispersing the support in the solution of the organometallic compound of the transition metal;
c) removing the organic solvent of the solution of the organometallic compound of the transition metal deposited on the surface of the support, and totally or partially decomposing the organometallic compound of the transition metal remaining on the surface of the support by effect of at least one heat treatment, the heat treatment being preceded by separation of the support from the solution of the organometallic compound of the transition metal, whereby one or more catalytic species of said transition metal are deposited on the support;
wherein before the contacting in step a) of the solution of the organometallic complex of the transition metal with the support, a first deposition of one or more transition metals is carried out on the support by impregnating the support with an aqueous solution of an inorganic salt or and organic solution of an organometallic complex of the transition metal, followed by drying and heating until decomposition of the inorganic salt or the organometallic complex, and deposition of the transition metal on the support.

19. The catalyst of claim 18, wherein the transition metal comprises one or more transition metals, or compounds of transition metals.

20. The catalyst of claim 19, wherein step a) is carried out with organic complexes of transition metals comprising Rh, Ru, and/or Ir.

21. The catalyst of claim 18, wherein the metal-carbonyls comprise one or more of: Rh₄(CO)₁₂; Rh₆(CO)₁₆; Ru₃(CO)₁₂; Ir₄ (CO)₁₂; Fe₂(CO)₉; Fe₃(CO)₁₂; CO₂(CO)₈; Co₄(CO)₁₂; and/or Co₆(CO)₁₆.

22. The catalyst of claim 18, wherein the organometallic compound with organic ligands of the transition metal is a complex in which the metal comprises one or more of: Co; Fe; Ni; Rh; Ru; Ir; Pt; and/or Pd, and in which the ligand is the RCOCHCOR′-group, where R and R′ can be the same or different and are C1-C6 alkyl groups.

23. The catalyst of claim 18, wherein the support is in the form of pellets or in the form of a monolithic structure and comprises one or more of: MgO; α-Al₂O₃; MgAlOx; CeO₂; La₂O₃; ZrO₂; TiO₂; perovskites; cordierite; and FeCrAl alloys.

24. A method comprising:
use of a catalyst in chemical processes comprising one or more of: CO₂ reforming; steam-CO₂ reforming; steam reforming; catalytic partial oxidation and low contact-time catalytic partial oxidation processes; and production of synthesis gas,
wherein the catalyst comprises catalytic species, the catalytic species comprising a transition metal deposited on a support comprising one or more of: inorganic oxides; nitrides; oxy-nitrides; carbides; borides; and metal compounds on a surface of which oxidic structures are formed,
wherein the catalyst is obtained by:
a) preparing a solution in an organic solvent of an organometallic compound of the transition metal forming the catalytic species and contacting it with the support, in which the organometallic compound is selected among the metal-carbonyls and complexes with organic ligands of the transition metal;
b) depositing the solution of the organometallic compound of the transition metal on the surface of the support with a chemisorption or physisorption process, wherein the depositing is carried out:
by contacting the solution of the organometallic compound of the transition metal using an incipient wetness impregnation of the support with the solution of the organometallic compound of the transition metal, or
by dispersing the support in the solution of the organometallic compound of the transition metal;
c) removing the organic solvent of the solution of the organometallic compound of the transition metal deposited on the surface of the support, and totally or partially decomposing the organometallic compound of the transition metal remaining on the surface of the support by effect of at least one heat treatment, the heat treatment being preceded by separation of the support from the solution of the organometallic compound of the transition metal, whereby one or more catalytic species of said transition metal are deposited on the support;
wherein before the contacting in step a) of the solution of the organometallic complex of the transition metal with the support, a first deposition of one or more transition metals is carried out on the support by impregnating the support with an aqueous solution of an inorganic salt or and organic solution of an organometallic complex of the transition metal, followed by drying and heating until decomposition of the inorganic salt or the organometallic complex, and deposition of the transition metal on the support.

25. The method of claim 24, wherein the transition metal comprises one or more transition metals, or compounds of transition metals.

26. The method of claim 25, wherein step a) is carried out with organic complexes of transition metals comprising Rh, Ru, and/or Ir.

27. The method of claim 24, wherein the metal-carbonyls comprise one or more of: Rh₄(CO)₁₂; Rh₆(CO)₁₆; Ru₃(CO)₁₂; Ir₄ (CO)₁₂; Fe₂(CO)₉; Fe₃(CO)₁₂; Co₂(CO)₈; Co₄(CO)₁₂; and/or Co₆ (CO)₁₆.

28. The method of claim 24, wherein the organometallic compound with organic ligands of the transition metal is a complex in which the metal comprises one or more of: Co; Fe; Ni; Rh; Ru; Ir; Pt; and/or Pd, and in which the ligand is the RCOCHCOR′-group, where R and R′ can be the same or different and are C1-C6 alkyl groups.

29. The method of claim 24, wherein the support is in the form of pellets or in the form of a monolithic structure and comprises one or more of: MgO; α-Al₂O₃; MgAlOx; CeO₂; La₂O₃; ZrO₂; TiO₂; perovskites; cordierite; and FeCrAl alloys.

30. The method of claim 24, further comprising use of the catalyst in production of synthesis gas, thereby reducing conditions of thermodynamic affinity with respect to formation of carbonaceous residues, and further reducing ratios between atoms of steam and atoms of carbon in reactant mixtures, and/or a ratio between oxygen atoms and carbon atoms.
